(19) United States
(12) Patent Application Publication
(10) Pub. No.: US 2016/0286755 A1
(43) Pub. Date: Oct. 6, 2016

(54) PET HEALTH AND LIFE MANAGEMENT SYSTEM AND METHOD HAVING SELF-LEARNING CAPABILITY

(71) Applicant: ALNpet Smart Technology (shanghai) Co., Ltd., Shanghai (CN)

(72) Inventor: Tang FENG, Hangzhou (CN)

(73) Assignee: ALNPET SMART TECHNOLOGY (SHANGHAI) CO., LTD., Shanghai (CN)

(21) Appl. No.: 14/921,227

(22) Filed: Oct. 23, 2015

(30) Foreign Application Priority Data
Apr. 3, 2015 (CN) 201510157922.8

(51) Int. Cl. A01K 5/02; G06N 99/00

(52) U.S. Cl. CPC A01K 5/0291; G06N 99/005; A01K 5/0283

(57) ABSTRACT

The invention provides a pet health and life management system and method having a self-learning capability, wherein the said system comprises a cloud data sever, an intelligent feeder, a mobile intelligent client, an intelligent portable device; wherein the intelligent portable device is arranged on or in the pet for acquiring activity information of the pet, and sending the acquired information to the cloud data sever or/and the corresponding intelligent feeder; wherein the cloud data server or/and the intelligent feeder is/are used for customizing a feeding scheme for the pet according to respective pieces of activity information of the pet, and the intelligent feeder acquires the feeding scheme; the intelligent feeder controls output feeding amount according to a corresponding feeding scheme. The invention can allocate type and amount of pet food according to different pets and activity conditions thereof.

### BACKGROUND

1. Technical Field

The present invention belongs to the technical field of electronic communication, and relates to a pet management system, in particular to a pet health and life management system having a self-learning capability; meanwhile, the present invention also relates to a pet health and life management method having a self-learning capability.

2. Related Art

Pet market has developed to a huge market, in America, the pets obviously become family members of the American, according to statistics of American Pet Products Association, in 2012, in all over America, pet dogs exceed 80 millions, pet cats exceed 90 millions, and 62% of American families keep pets. A pet fever appears around the world including China, according to incomplete statistics, ratio of families keeping pets in first-tire cities in China is up to 12% already, and pet owners who age under 35 account for more than 70%. The pets are a market in the ascendant, and in 2013, scale of the US pet market is 550 dollars.

While the pets bring joy to owners, more pet keeping troubles exist, the pets cannot speak in human language, human cannot accurately know actions of the pets, and can only guess thoughts and whether they are happy, sad, angry or healthy by getting along with the pets in long term. In addition, after all, human and the pets come from two worlds, and we can only understand little of the pet world, lack communication manners and impose self habits on them, which results in harm to them, for example, the pets have a diet structure different from that of human, due to different diet habits, chocolate is delicious to humans but poisonous to the pets, huge harm is caused to the pets due to excessive uptake of salt, how to keep the pets from obesity and the like; according to statistics of Association for Pet Obesity Prevention, more than 50% of pets have overweight or obesity in America.

Aiming at above problems, no good products are available on the market to meet systematical demands, for example, the currently commercially available automatic feeders with timing and quantifying functions or feeders controlled by remote networking are only extension when owners are not at home, and problems that the pets are fed according to feeling of the owners, whether nutrition of the pets is enough or not, and whether today the pets eat more or less still cannot be determined.

Necklaces for the pets to wear are also available on the market, can be used for detecting everyday activity information of pets, and learning certain conditions of the pets, for example, whether the everyday moving amount is enough, how long the pets sleep, and health conditions of the pets, are huge progress on learning of the pets, but only stay at the surface of information collection without providing substantial help to the health life of the pets.

For this purpose, a pet health and life management system having a self-learning capability needs to be designed urgently to provide effective innovation on the prior art aiming at above aspects.

### SUMMARY

The present invention aims to solve the technical problem of providing a pet health and life management system having a self-learning capability, which can allocate type and amount of pet food according to different pets and activity conditions thereof.

In addition, the present invention also provides a pet health and life management method having a self-learning capability, which can allocate type and amount of pet food according to different pets and activity conditions thereof.

In order to solve the technical problem, the present invention adopts the following technical solution:

the pet health and life management system with the self-learning capability comprises a cloud data sever, an intelligent feeder, a mobile intelligent client, intelligent camera devices, an intelligent necklace, and an intelligent electronic scale;

the cloud data sever is connected with the intelligent feeder, the mobile intelligent client and the intelligent camera devices respectively, and the mobile intelligent client is connected with the intelligent feeder, the intelligent necklace and the intelligent electronic scale respectively;

the cloud data server can customize a feeding scheme according to pets of different varieties, different ages and different body weights, the everyday feeding amount is analyzed and adjusted by large data, the feeding amount is mainly determined according to measuring data of calorie content of each cup of pet food of different varieties of Association for Pet Obesity Prevention (APOP), everyday calorie consumption corresponding to pet standard body weight data, everyday calorie consumed by moving of the pets, pet variety statistic data of American Kennel Club (AKC) and a series of data, and an optimal scientific feeding scheme is provided for the pets by scientific calculation and analysis;

an optimal feeding scheme reference table is stored in the cloud data server, and has corresponding pet food weights aiming at different varieties, different ages, different sexes, different pet food, different body weights, different activities and different seasons;

the cloud data server comprises a self-learning module which is used for acquiring body weight and activity of the pets every set time interval; comparing a body weight curve of each pet with a set body weight curve, adding 1 to a comparative value of corresponding variety pet if the comparative value exceeds a set threshold value, and correcting the optimal feeding scheme reference table if the comparative value is up to the set value; reducing the corresponding feeding amount in the optimal feeding scheme reference table if the body weight is increased too fast, and increasing the corresponding feeding amount in the optimal feeding scheme reference table if the body weight is increased too slow; and then setting the comparative value of pet of such variety as 0;

the cloud data sever is the center of the whole system, and stores massive raw data, comprising: 1) all pet dog varieties defined by AKC, average body weight of adult male and female pets, and pup average body weight defined by science research; 2) popular pet food brand and variety on the market and calorie contents of corresponding pet food; 3) everyday required calorie uptake relative to the variety, age and body weight of the pet dogs suggested by experts through science research; 4) everyday required water uptake relative to the variety, age and body weight of the pet dogs suggested by experts through science research;

the mobile intelligent client is a portable partner of a pet owner, establishes data transmission with the cloud data server by a wireless wideband network, establishes communication with other intelligent terminals by a Bluetooth module, can be used for learning the condition of every moment of the pet, comprising feeding amount of every meal, drinking amount, moving information, and healthy condition, and can establish video interaction with the pet; in addition, the mobile terminal client is the most main input equipment and control unit of the pet owner, and can start the video communication function of the intelligent feeder by video button operation, and the pet owner can communicate with the pet remotely and can see the pet condition;

the system comprises a plurality of intelligent camera devices, which can know every action of the pet from each angle, and can know the behavior of the pet anytime;

the pet intelligent necklace is used for collecting everyday activity information of the pet, giving corresponding calorie consumption by calculation, and establishing communication with the mobile intelligent client or the intelligent feeder to transmit data to the cloud data sever, the cloud data sever synthesizes various pieces of information, and obtains the food amount which is should be fed every day or every meal and issues a command to the intelligent feeder which feeds the pet; as the moving amount of the pet is different every day, consumption of calories is different, the cloud data sever balances the different between the calorie consumption converted according to the moving amount of the pet and the standard calorie required amount to dynamically adjust the feeding amount, so as to avoid too much or too little food uptake of the pet and avoid excessive obesity or leanness;

the intelligent electronic scale is used for precisely measuring body weight of the pet and is placed in front of the intelligent feeder during use, when the pet eats the pet food every time, the pet stands on the intelligent electronic scale, and the body weight is automatically detected every time the pet eats the pet food; the intelligent electronic scale transmits the body weight data measured every day to the cloud data server by the mobile intelligent client or the intelligent feeder, if the condition that the pet is too much fat or thin is found, the cloud data server adjusts the everyday feeding amount at proper time, and through such a cyclic process, the system dynamically adjusts the feeding amount and keeps the pet healthy;

the intelligent feeder is the center connected with related intelligent equipment in a family, has a precise feeding function on one aspect, has a data transmission function on the other aspect and also has a video interaction entertainment function; the intelligent pet feeder mainly consists of a central processing unit, a communication unit, a food storage barrel, a discharging mechanism, an electronic scale, a telescopic feeding bowl, a camera, a first motor and a second motor; the central processing unit is respectively connected with the communication unit, the electronic scale, a transmission mechanism, the camera, the first motor and the second motor;

the intelligent feeder is connected to the internet by WiFi, establishes communication with the cloud data server, establishes communication with other intelligent equipment by Bluetooth, transmits data to the cloud data server, and receives a command of the cloud data server to operate;

the pet food storage barrel is arranged at the upper half part of the intelligent feeder, and can store the pet food of more than 5 kg, the spiral discharging mechanism is arranged at the bottom of the storage barrel, and the telescopic feeding bowl is arranged at the lower half part of the food storage barrel; two motors are arranged in the intelligent feeder, the first motor is used for rotation of the discharging mechanism and the second motor is used for telescoping the feeding bowl; four weighing sensors are arranged at the bottom of the whole intelligent feeder and are controlled by the central processing unit for precisely measuring weight of the consumed pet food; a high definition camera and a microphone are arranged at the front surface of the intelligent feeder, a horn is arranged at the side surface and controlled by the central processing unit, the intelligent feeder can directly establish video communication with the mobile intelligent client;

after the intelligent feeder obtains a feeding command of the cloud data server, the intelligent feeder commands the transmission mechanism to convey required pet food to the feeding bowl by the control unit, and then commands the transmission mechanism to push out the feeding bowl to feed the pet;

after the pet eats the food, the feeding bowl retreats, the electronic scale is commanded to work to transmit the accurate feeding amount data of the meal to the cloud data server, thus finishing the whole eating operation;

a whole precise feeding process is as follows: firstly the moving data of the pet is collected by the intelligent necklace, then the intelligent feeder sends specific sound of feeding to call the pet to come over to eat, when the pet approaches to the intelligent feeder, the intelligent necklace establishes communication connection with the intelligent feeder by a Bluetooth module, and uploads moving data to the cloud data server by the network, moving amount is input to the cloud data server, the feeding amount of this meal is calculated by a complex algorithm according to variety, age, sex, body weight, standard feeding amount and standard calorie information of the pet, the cloud data server sends a command to the intelligent feeder which receives the feeding amount command, and the control unit controls a discharging motor to rotate by certain circles; the feeding amount is different according to different pet food varieties, and the data is obtained by experiment and matched with a relation between the pet food feeding amount and rotation of the motor; after discharging, the control unit controls the discharging motor to rotate, and pushes a food bowl filled with the pet food out of the intelligent feeder for the pet to enjoy; after set time, the control unit controls the discharging motor to recover the food bowl no matter the pets eats up or not, after recovery, the control unit controls the electronic scale to weigh residual pet food, an accurate value of this time feeding is obtained and is uploaded to the data server, and once feeding is finished.

As a preferable scheme of the present invention, the system also comprises an intelligent dispenser, which is used for automatically detecting the balance of water, knowing everyday drinking amount of the pet and judging everyday water uptake of the pet.

A pet health and life management system having a self-learning capability comprises a cloud data server, an intelligent feeder and an intelligent portable device;

the cloud data sever is connected with the intelligent feeder, and the intelligent feeder is connected with the intelligent portable device;

the intelligent portable device is arranged on or in the pet for acquiring activity information of the pet, and sending the acquired information to the cloud data sever or/and the corresponding intelligent feeder;

the cloud data server or/and the intelligent is/are used for customizing a feeding scheme for the pet according to respective pieces of activity information of the pet, and the intelligent feeder acquires the feeding scheme; the intelligent feeder controls output feeding amount according to a corresponding feeding scheme.

As a preferable scheme of the present invention, the system also comprises at least one intelligent client, and the intelligent client is connected with the intelligent feeder and the intelligent portable device;

the cloud data server or/and the intelligent feeder/or/and the intelligent client is/are used for customizing a feeding scheme for the pet according to respective pieces of activity information of the pet, and the intelligent feeder acquires the feeding scheme.

As a preferable scheme of the present invention, an optimal feeding scheme reference table is stored in the cloud data server, and has corresponding pet food weights aiming at different varieties, different ages, different sexes, different pet food, different body weights, different activities and different seasons.

As a preferable scheme of the present invention, the cloud data server comprises a self-learning module, which is used for acquiring body weight and activity of the pets every set time interval; comparing a body weight curve of each pet with a set body weight curve, adding 1 to the comparative value of corresponding variety pet if the comparative value exceeds a set threshold value, and correcting the optimal feeding scheme reference table if the comparative value is up to the set value; reducing the corresponding feeding amount in the optimal feeding scheme reference table if the body weight is increased too fast, and increasing the corresponding feeding amount in the optimal feeding scheme reference table if the body weight is increased too slow; and then setting the comparative value of pet of such variety as 0.

As a preferable scheme of the present invention, the intelligent portable device is used for collecting everyday activity information of the pet, calculating corresponding calorie consumption, and establishing communication with the mobile intelligent client or the intelligent feeder to transmit data to the cloud data sever, the cloud data sever synthesizes various pieces of information, and obtains the food amount which is should be fed every day or every meal and issues a command to the intelligent feeder which feeds the pet;

as the moving amount of the pet is different every day, consumption of calories is different, the cloud data sever balances the different between the calorie consumption converted according to the moving amount of the pet and the standard calorie required amount to dynamically adjust feeding amount, so as to avoid too much or too little food eating of the pet and avoid excessive obesity or leanness;

the cloud data server performs horizontal comparison on myriads of pet dogs of the same variety, same sex and same age in the system and further adjusts the everyday feeding amount to enable the feeding amount of the pets to be more precise, scientific and reasonable.

As a preferable scheme of the present invention, the intelligent portable device is a pet intelligent necklace, which is wore on pet's neck.

As a preferable scheme of the present invention, the intelligent feeder is a center connected with related intelligent equipment in a family, has a precise feeding function on one aspect, has a data transmission function on the other aspect and also has a video interaction entertainment function; the intelligent pet feeder mainly consists of a central processing unit, a communication unit, a food storage barrel, a discharging mechanism, an electronic scale, a telescopic feeding bowl, a camera, a first motor and a second motor; the central processing unit is respectively connected with the communication unit, the electronic scale, a transmission mechanism, the camera, the first motor and the second motor;

the pet food storage barrel is arranged at the upper half part of the intelligent feeder, and can store the pet food of more than 5 kg, the spiral discharging mechanism is arranged at the bottom of the storage barrel, and the telescopic feeding bowl is arranged at the lower half part of the food storage barrel; two motors are arranged in the intelligent feeder, the first motor is used for rotation of the discharging mechanism and the second motor is used for telescoping the feeding bowl; four weighing sensors are arranged at the bottom of the whole intelligent feeder and are controlled by the central processing unit for precisely controlling weight of the consumed pet food;

the intelligent feeder is connected to the internet by WiFi, establishes communication with the cloud data server, establishes communication with other intelligent equipment by Bluetooth, transmits data to the cloud data server, and receives a command of the cloud data server to operate;

As a preferable scheme of the present invention, the system also comprises a high definition camera and a microphone are arranged at the front surface of the intelligent feeder, a horn is arranged at the side surface and controlled by the central processing unit, the intelligent feeder can directly establish video communication with the mobile intelligent client.

As a preferable scheme of the present invention, the system also comprises intelligent camera devices, an intelligent water dispenser, and an intelligent electronic scale; the intelligent camera device is connected with the cloud data server, the intelligent water dispenser is connected with the intelligent feeder, and the intelligent electronic scale is connected with the intelligent client;

the system comprises the intelligent camera device for acquiring audio and video information of the pet, when a pet owner is not at home, the pet owner can communicate with the pet remotely, affective communication with the pet can be enhanced and life of the pet is more healthy;

the intelligent water dispenser is used for automatically detecting the balance of water, knowing everyday drinking amount of the pet anytime and judging everyday water uptake of the pet;

the intelligent electronic scale is used for acquiring the body weight information of the pet; the intelligent electronic scale transmits the body weight data measured every day to the cloud data server by the mobile intelligent client or the intelligent feeder, if the condition that the pet is too much fat or thin is found, the cloud data server adjusts the everyday feeding amount at proper time, and through such a cyclic process, the system dynamically adjusts the feeding amount and keeps the pet healthy.

As a preferable scheme of the present invention, the cloud data server is the center of the whole system and raw data, comprising: 1) all pet dog varieties defined by AKC, average body weight of adult male and female pets, and pup average body weight defined by science research; 2) popular pet food brand and variety on the market and calorie contents of corresponding pet food; 3) everyday required calorie uptake relative to the variety, age and body weight of the pet dogs suggested by experts through science research; 4) everyday required water uptake relative to the variety, age and body weight of the pet dogs suggested by experts through science research.

A pet health and life management method of having a self-learning capability comprises following steps that:

the intelligent portable device is arranged on or in the pet for acquiring activity information of the pet, and sending the acquired information to the corresponding intelligent client or/and cloud data sever or/and the corresponding intelligent feeder;

the cloud data server or/and the intelligent client or/and the intelligent feeder is/are used for customizing a feeding scheme for the pet according to respective pieces of activity information of the pet, and the intelligent feeder acquires the feeding scheme; the intelligent feeder controls output feeding amount according to a corresponding feeding scheme.

As a preferable scheme of the present invention, the method specifically comprises the following steps that:

moving data of the pet is collected by the intelligent portable device; then the intelligent feeder sends specific sound of feeding to call the pet to come over to eat when ifs time to feed the pet;

when the pet approaches to the intelligent feeder, the intelligent portable device establishes communication connection with the intelligent feeder by Bluetooth, and uploads moving data to the cloud data server by the network;

moving amount is input to the cloud data server, the feeding amount of this meal is calculated by a complex algorithm according to variety, age, sex, body weight, standard feeding amount and standard calorie information of the pet;

the cloud data server sends a command to the intelligent feeder which receives the feeding amount command, and the control unit controls a discharging motor to rotate by certain circles; the feeding amount is different according to different pet food varieties, and the data is obtained from the optimal feeding scheme reference table arranged in the cloud data server and matched with a relation between the pet food feeding amount and rotation of the motor;

after discharging, the control unit controls the discharging motor to rotate, and pushes a food bowl filled with the pet food out of the intelligent feeder for the pet to enjoy;

after set time, the control unit controls the discharging motor to recover the food bowl no matter the pets eats up or not, after recovery, the control unit controls the electronic scale to weigh residual pet food, an accurate value about this time feeding is obtained and is uploaded to the data server, and once feeding is finished;

As a preferable scheme of the present invention, the method specifically comprises the following steps that: the mobile intelligent client starts a video communication function of the intelligent feeder by video button operation, and a pet owner can communicate with the pet remotely and see the condition of the pet.

The present invention has the beneficial effects: the pet health and life management system with the self-learning capability and the method can allocate varieties and number of pet food according to different pets and activity conditions thereof.

### BRIEF DESCRIPTION OF THE DRAWINGS

FIG. 1 is a constitution schematic diagram of a pet health and life management system of the present invention.

FIG. 2 is a connection schematic diagram of main parts of the pet health and life management system of the present invention.

FIG. 3 is the other connection schematic diagram of the main parts of the pet health and life management system of the present invention.

### DETAILED DESCRIPTION

Preferable embodiments of the present invention are described in detailed in combination with the drawings.

### Embodiment I

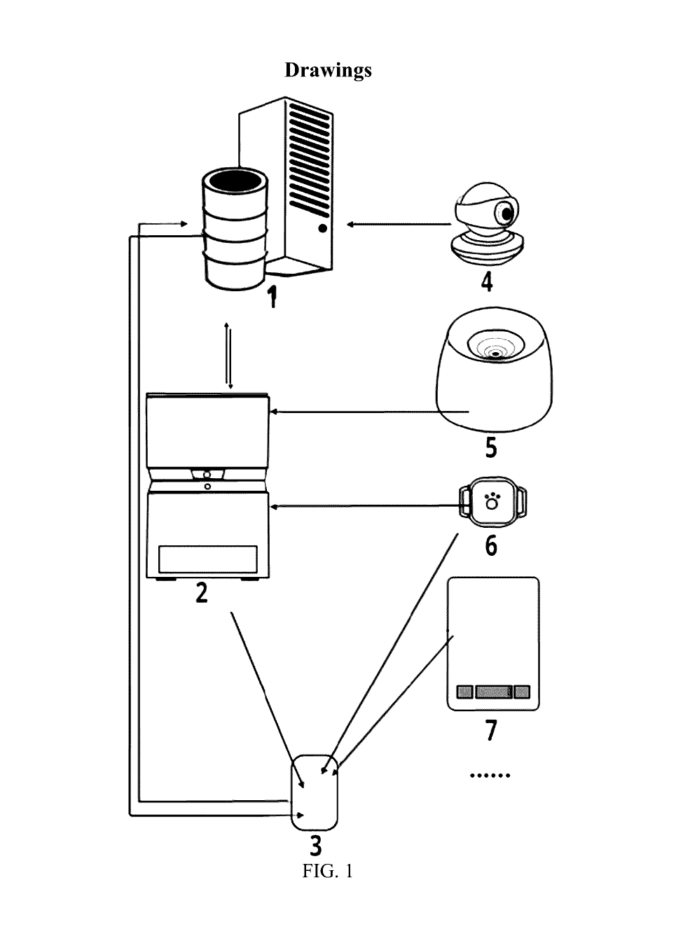

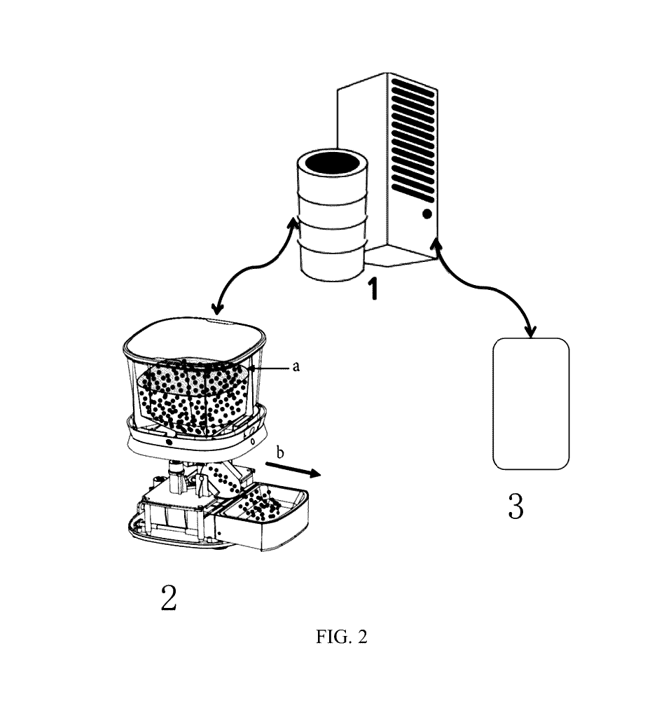

With reference to FIGS. 1-3, the present invention discloses a pet health and life mange system having a self-learning capability, which comprises a cloud data sever 1, an intelligent feeder 2, a mobile intelligent client 3, intelligent camera devices 4, an intelligent dispenser 5, an intelligent necklace 6, and an intelligent electronic scale 7. The cloud data sever 1 is connected with the intelligent feeder 2, the mobile intelligent client 3 and the intelligent camera devices 4 respectively, and the mobile intelligent client 3 is connected with the intelligent feeder 2, the intelligent necklace 6 and the intelligent electronic scale 7 respectively;

The present invention can provide automatic weighing, feeding, water drinking, interaction entertainment and other functions for pets, and creates an intelligent health and life for the pets, meanwhile, the system has a self-learning capability and management capability, can customize a feeding scheme for the pets of different varieties, different ages and different body weights, provides an optimal scientific feeding scheme for the pets by large data analysis, and makes your pets more healthy.

[Cloud Data Server]

The cloud data sever 1 of the system of the present invention is a center system of the whole system, and stores massive raw data, comprising:

(1) all pet dog varieties defined by AKC (American Kennel Club) (also comprising other pet dog varieties), average body weight of adult male and female pets, and pup average body weight defined by science research;

(2) popular pet food brand and variety on the market and calorie contents of corresponding pet food;

(3) everyday required calorie uptake relative to the variety, age and body weight of the pet dogs suggested by experts through science research;

(4) everyday required water uptake relative to the variety, age and body weight of the pet dogs suggested by experts through science research;

The cloud data server 1 performs horizontal comparison on myriads of pet dogs of the same variety, same sex and same age in the system and further adjusts the everyday feeding amount to enable the feeding amount of the pets to be more precise, scientific and reasonable.

In the embodiment, an optimal feeding scheme reference table is stored in the cloud data server, and has corresponding pet food weights aiming at different varieties, different ages, different sexes, different pet food, different body weights, different activities and different seasons.

The cloud data server 1 comprises a self-learning module which is used for acquiring body weight and activity of the pets every set time interval; comparing a body weight curve of each pet with a set body weight curve, adding 1 to the comparative value of corresponding variety pet if the comparative value exceeds a set threshold value, and correcting the optimal feeding scheme reference table if the comparative value is up to the set value (the set value may be dynamic, for example, if the total number of the pets of such variety using the system is 1000, the set value can be 500 or 600); reducing the corresponding feeding amount in the optimal feeding scheme reference table if the body weight is increased too fast (the comparative value exceeds the set threshold value every set time interval), and increasing the corresponding feeding amount in the optimal feeding scheme reference table if the body weight is increased too slow (the comparative value is smaller than the set threshold value every set time interval); and then setting the comparative value of pet of such variety as 0.

The present invention can be used for classification by taking seasons as unit (by taking months as unit, or by taking weeks of every year as unit even by taking date as unit), and different seasons (months, weeks and dates) have different reference tables.

[Pet Intelligent Necklace]

Then, the pet intelligent necklace 6 is used for collecting everyday activity information of the pet, giving corresponding calorie consumption by science research experiment and algorithm, and establishing communication with the mobile intelligent client 3 or the intelligent feeder 2 to transmit data to the cloud data sever 1, the cloud data sever 1 synthesizes various pieces of information, and obtains the food amount which is should be fed every day or every meal and issues a command to the intelligent feeder 2 which feeds the pet.

As the moving amount of the pet is different every day, consumption of calories is different, the cloud data sever 1 balances the different between the calorie consumption converted according to the moving amount of the pet and the standard calorie required amount to dynamically adjust feeding amount, so as to avoid too much or too little food eating of the pet and avoid excessive obesity or leanness.

The pet intelligent necklace comprises a triaxis acceleration sensor and a microcontroller module.

The triaxis acceleration sensor adopted by the intelligent necklace is widely used in cars, cellphones and intelligent portable equipment, can precisely measure acceleration signals when the pet walks, runs and sleeps, and then compares with the height and body weight data of the pet, calorie consumption of the pet during walking, running and sleeping can be obtained by a related algorithm of the built-in microcontroller, and the intelligent necklace has the advantages of low power consumption, high precision and sensibility and the like.

[Mobile Intelligent Client]

The mobile intelligent client 3 designed in the present invention is a portable partner of a pet owner, establishes data transmission with the cloud data server 1 by a wireless wideband network, establishes communication with other intelligent terminals by Bluetooth 4.0 (also by other communication manners such as WiFi and ZigBee of course), can be used for learning the condition of every moment of the pet, comprising feeding amount of each meal, drinking amount, moving information, and healthy condition, and can establish video interaction with the pet; in addition, the mobile terminal client 3 is the most main input equipment and control unit of a pet owner. The mobile intelligent client 3 may be a cellphone or a tablet computer.

[Intelligent Cameras]

The system comprises a plurality of intelligent equipment as intelligent camera devices 4, which are arranged at different directions, can know every action of the pet from each angle, and can know the behavior of the pet anytime;

[Intelligent Water Dispenser]

The intelligent water dispenser 5 designed by the present invention can be used for automatically detecting the balance of water, knowing everyday drinking amount of the pet and judging everyday water uptake of the pet.

[Intelligent Electronic Scale]

The intelligent electronic scale 7 designed in the present invention can be used for precisely measuring body weight of the pet, and is placed in front of the intelligent feeder 2 during use, when the pet eats the pet food every time, the pet stands on the intelligent electronic scale 7, the body weight is measured every time the pet eats pet food, and is transmitted to the cloud data server 1 by the intelligent feeder 2 or the mobile intelligent client 3.

Meanwhile, the intelligent electronic scale 7 transmits the body weight data measured every day to the cloud data sever 1 by the mobile intelligent client 3 or the intelligent feeder 2, if finding that the pet is too much fat or thin, the cloud data server 1 compares with the pet body weight of a standard figure in a database, and reduces or increases the feeding amount according to a difference value, this is a linear calculation formula, the adjustment is performed for a month, comparison with the standard body weight is performed after a month, whether the current feeding scheme achieves a good effect is estimated, the feeding amount is systematically dynamically adjusted through such a cyclic process, and the pet is kept healthy.

[Intelligent Feeder]

The intelligent feeder 2 designed in the present invention is the center connected with related intelligent equipment in a family, has a precise feeding function on one aspect, has a data transmission function on the other aspect and also has a video interaction entertainment function. The intelligent pet feeder mainly consists of an intelligent control unit (namely central processing unit), a communication unit, a food storage barrel, an electronic scale, transmission mechanism, a telescopic feeding bowl, a camera and the like.

A main function process is as follows: the intelligent feeder 2 is connected to the internet by WiFi, establishes communication with the cloud data server 1, establishes communication with other intelligent equipment by Bluetooth, transmits data to the cloud data server 1, and receives a command of the cloud data server 1 to operate.

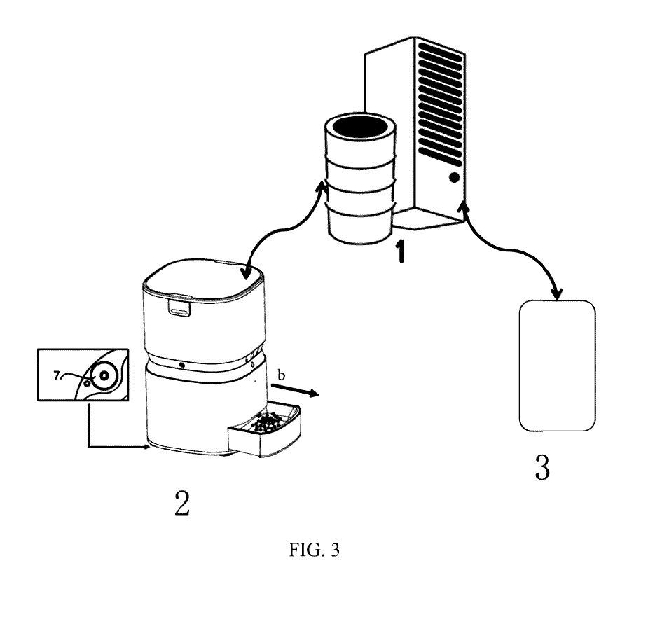

The central processing unit with high integration level is arranged in the intelligent feeder 2, and adopts a Linux system. In combination with FIG. 3, the pet food storage barrel is arranged at the upper half part a of the intelligent feeder 2, and can store the pet food of more than 5 kg, a spiral discharging mechanism is arranged at the bottom of the storage barrel, and the telescopic feeding bowl is arranged at the lower half part b of the food storage barrel.

Two motors are arranged in the intelligent feeder 2, one motor is used for rotation of the discharging mechanism and the other motor is used for telescoping the feeding bowl. Four weighing sensors are arranged at the bottom of the whole intelligent feeder 2 and are controlled by the central processing unit for precisely measuring weight of the consumed pet food (accurate to grams). A high definition camera and a microphone are arranged at the front surface of the intelligent feeder 2, a horn is arranged at the side surface and controlled by the central processing unit, and the intelligent feeder can directly establish video communication with the mobile intelligent client 3.

After acquiring a feeding command of the cloud data server 1, the intelligent feeder 2 commands the transmission mechanism to convey required pet food to a feeding bowl by the control unit, and then commands the transmission mechanism to push out the feeding bowl to feed the pet (as shown in FIG. 4).

After the pet eats the food, the feeding bowl retreats, the electronic scale is commanded to work to transmit the accurate feeding amount of the meal to the cloud data server 1, thus finishing the whole eating operation.

A whole precise feeding process is as follows: firstly the moving data of the pet is collected by the intelligent necklace 6, then the intelligent feeder 2 sends specific sound of feeding to call the pet to come over to eat, when the pet approaches to the intelligent feeder 2, the intelligent necklace 6 establishes communication connection with the intelligent feeder 2 by Bluetooth, and uploads moving data to the cloud data server 1 by the network, moving amount is input to the cloud data server 1, the feeding amount of this meal is calculated by a complex algorithm according to variety, age, sex, body weight, standard feeding amount and standard calorie information of the pet, the cloud data server 1 sends a command to the intelligent feeder 2 which receives the feeding amount command, and the control unit controls a discharging motor to rotate by certain circles (the feeding amount is different according to different pet food varieties, and the data is obtained by experiment and matched with a relation between the pet food feeding amount and rotation of the motor), after discharging, the control unit controls the discharging motor to rotate, and pushes a food bowl filled with the pet food out of the intelligent feeder for the pet to enjoy. After ten minutes, the control unit controls the discharging motor to recover the food bowl no matter the pets eats up or not, after recovery, the control unit controls the electronic scale to weigh residual pet food, an accurate value about this time feeding is obtained and is uploaded to the data server, and once feeding is finished.

The mobile intelligent client 3 starts a video communication function of the intelligent feeder 2 by video button operation, and a pet owner can communicate with the pet remotely and see the condition of the pet.

In addition, the system of the present invention can be provided with a plurality of other intelligent pet accessories which can provide service for the pet.

Constitution of the pet health and life management system with the self-learning capability of the present invention is described above, while disclosing the management system, the present invention also discloses a pet health and life management method having a self-learning capability; the method comprises the following steps that:

the intelligent portable device is arranged on or in the pet for acquiring activity information of the pet, and sending the acquired information to the corresponding intelligent client or/and the cloud data sever or/and the corresponding intelligent feeder;

the cloud data server or/and the intelligent client or/and the intelligent feeder is/are used for customizing a feeding scheme for the pet according to respective pieces of activity information of the pet, and the intelligent feeder acquires the feeding scheme; the intelligent feeder controls output feeding amount according to a corresponding feeding scheme.

Specifically, the method comprises the following steps that:

Step S1, moving data of the pet is collected by the intelligent portable device; then the intelligent feeder sends specific sound of feeding to call the pet to come over to eat when it's time to feed the pet;

Step S2, when the pet approaches to the intelligent feeder, the intelligent portable device establishes communication connection with the intelligent feeder by Bluetooth, and uploads moving data to the cloud data server by the network;

Step S3, moving amount is input to the cloud data server, the feeding amount of this meal is calculated by a complex algorithm according to variety, age, sex, body weight, standard feeding amount and standard calorie information of the pet;

Step S4, the cloud data server sends a command to the intelligent feeder which receives the feeding amount command, and the control unit (namely the central processing unit) controls a discharging motor to rotate by certain circles; the feeding amount is different according to different pet food varieties, and the data is obtained from the optimal feeding scheme reference table arranged in the cloud data server and matched with a relation between the pet food feeding amount and rotation of the motor;

Step S5, after discharging, the control unit controls the discharging motor to rotate, and pushes a food bowl filled with the pet food out of the intelligent feeder for the pet to enjoy;

Step S6, after set time (for example ten minutes), the control unit controls the discharging motor to recover the food bowl no matter the pets eats up or not, after recovery, the control unit controls the electronic scale to weigh residual pet food, an accurate value about this time feeding is obtained and is uploaded to the data server, and once feeding is finished;

Step S7, the mobile intelligent client starts a video communication function of the intelligent feeder by video button operation, and a pet owner can communicate with the pet remotely and see the condition of the pet.

### Embodiment II

The difference between the embodiment and the embodiment I lies in that in the embodiment, the intelligent necklace 6 may be other intelligent portable devices, which are arranged on the pet or other positions of the pet.

### Embodiment III

The difference between the embodiment and the embodiment I lies in that in the embodiment, the mobile intelligent client 3 is not comprised, and information collection of the intelligent necklace 6 is realized by the intelligent feeder 2.

In conclusion, the pet health and life management system and method with the self-learning capability provided by the present invention can automatically allocate amount of pet food according to different pets and activity conditions thereof without artificial interference.

The system of the present invention has the feeding system with a self-learning function, considers every aspect of the pets, such as feeding, water drinking, moving and the like and feeds the pets systematically scientifically, so the pets can communicate with a pet owner in real time and know all conditions of the pets.

Description and application herein of the present invention are exemplary, and do not intend to limit the scope of the present invention in the embodiments. Transformation and alteration of the embodiment disclosed herein are possible, and substitution of the embodiments and equivalent respective parts are known for those skilled in the art. It should be clear to those skilled in the art that the present invention can be realized in other forms, structures, configurations, proportions and other assemblies, materials and parts without departing from the spirit and essence of the present invention. The embodiments disclosed herein can be subject to other transformations and alterations without departing from the spirit and essence of the present invention.

What claimed is:

1. A pet health and life management system with the self-learning capability, comprising: a cloud data sever, an intelligent feeder, a mobile intelligent client, intelligent camera devices, an intelligent dispenser, an intelligent necklace, and an intelligent electronic scale;
wherein the cloud data sever is connected with the intelligent feeder, the mobile intelligent client and the intelligent camera devices respectively, and the mobile intelligent client is connected with the intelligent feeder, the intelligent necklace and the intelligent electronic scale respectively;
wherein the cloud data server can customize a feeding scheme according to pets of different varieties, different ages and different body weights, the everyday feeding amount is analyzed and adjusted by large data, the feeding amount is mainly determined according to measuring data of calorie content of each cup of pet food of different varieties of Association for Pet Obesity Prevention, everyday calorie consumption corresponding to pet standard body weight data, everyday calorie consumed by moving of the pets, pet variety statistic data of American Kennel Club and a series of data, and an optimal scientific feeding scheme is provided for the pets by scientific calculation and analysis;
wherein an optimal feeding scheme reference table is stored in the cloud data server, and has corresponding pet food weights aiming at different varieties, different ages, different sexes, different pet food, different body weights, different activities and different seasons;
wherein the cloud data server comprises a self-learning module which is used for acquiring body weight and activity of the pets every set time interval; comparing a body weight curve of each pet with a set body weight curve, adding 1 to a comparative value of corresponding variety pet if the comparative value exceeds a set threshold value, and correcting the optimal feeding scheme reference table if the comparative value is up to the set value; reducing the corresponding feeding amount in the optimal feeding scheme reference table if the body weight is increased too fast, and increasing the corresponding feeding amount in the optimal feeding scheme reference table if the body weight is increased too slow; and then setting the comparative value of pet of such variety as 0;
wherein the cloud data sever is the center of the whole system, and stores massive raw data, comprising: 1) all pet dog varieties defined by AKC, average body weight of adult male and female pets, and pup average body weight defined by science research; 2) popular pet food brand and variety on the market and calorie contents of corresponding pet food; 3) everyday required calorie uptake relative to the variety, age and body weight of the pet dogs suggested by experts through science research; 4) everyday required water uptake relative to the variety, age and body weight of the pet dogs suggested by experts through science research;
wherein the mobile intelligent client is a portable partner of a pet owner, establishes data transmission with the cloud data server by a wireless wideband network, establishes communication with other intelligent terminals by a Bluetooth module, can be used for learning the condition of every moment of the pet, comprising feeding amount of every meal, drinking amount, moving information, and healthy condition, and can establish video interaction with the pet; in addition, the mobile terminal client is the most main input equipment and control unit of the pet owner, and can start the video communication function of the intelligent feeder by video button operation, and the pet owner can communicate with the pet remotely and can see the pet condition;
the said system comprises a plurality of intelligent camera devices, which can know every action of the pet from each angle, and can know the behavior of the pet anytime;
wherein the pet intelligent necklace is used for collecting everyday activity information of the pet, giving corresponding calorie consumption by calculation, and establishing communication with the mobile intelligent client or the intelligent feeder to transmit data to the cloud data sever, the cloud data sever synthesizes various pieces of information, and obtains the food amount which is should be fed every day or every meal and issues a command to the intelligent feeder which feeds the pet; as the moving amount of the pet is different every day, consumption of calories is different, the cloud data sever balances the different between the calorie consumption converted according to the moving amount of the pet and the standard calorie required amount to dynamically adjust the feeding amount, so as to avoid too much or too little food uptake of the pet and avoid excessive obesity or leanness;
wherein the intelligent electronic scale is used for precisely measuring body weight of the pet and is placed in front of the intelligent feeder during use, when the pet eats the pet food every time, the pet stands on the intelligent electronic scale, and the body weight is automatically detected every time the pet eats the pet food; the intelligent electronic scale transmits the body weight data measured every day to the cloud data server by the mobile intelligent client or the intelligent feeder, if the condition that the pet is too much fat or thin is found, the cloud data server adjusts the everyday feeding amount at proper time, and through such a cyclic process, the system dynamically adjusts the feeding amount and keeps the pet healthy;
wherein the intelligent feeder is the center connected with related intelligent equipment in a family, has a precise feeding function on one aspect, has a data transmission function on the other aspect and also has a video interaction entertainment function; the intelligent pet feeder mainly consists of a central processing unit, a communication unit, a food storage barrel, a discharging mechanism, an electronic scale, a telescopic feeding bowl, a camera, a first motor and a second motor; the central processing unit is respectively connected with the communication unit, the electronic scale, a transmission mechanism, the camera, the first motor and the second motor;
wherein the intelligent feeder is connected to the internet by WiFi, establishes communication with the cloud data server, establishes communication with other intelligent equipment by Bluetooth, transmits data to the cloud data server, and receives a command of the cloud data server to operate;
wherein the pet food storage barrel is arranged at the upper half part of the intelligent feeder, and can store the pet food of more than 5 kg, the spiral discharging mechanism is arranged at the bottom of the storage barrel, and the telescopic feeding bowl is arranged at the lower half part of the food storage barrel; two motors are arranged in the intelligent feeder, the first motor is used for rotation of the discharging mechanism and the second motor is used for telescoping the feeding bowl; four weighing sensors are arranged at the bottom of the whole intelligent feeder and are controlled by the central processing unit for precisely measuring weight of the consumed pet food; a high definition camera and a microphone are arranged at the front surface of the intelligent feeder, a horn is arranged at the side surface and controlled by the central processing unit, the intelligent feeder can directly establish video communication with the mobile intelligent client;
after the intelligent feeder obtains a feeding command of the cloud data server, the intelligent feeder commands the transmission mechanism to convey required pet food to the feeding bowl by the control unit, and then commands the transmission mechanism to push out the feeding bowl to feed the pet;
after the pet completed the feeding, the feeding bowl retreats, the electronic scale is commanded to work to transmit the accurate feeding amount data of the meal to the cloud data server, thus finishing the whole eating operation;
a whole precise feeding process is as follows: firstly the moving data of the pet is collected by the intelligent necklace, then the intelligent feeder sends specific sound of feeding to call the pet to come over to eat, when the pet approaches to the intelligent feeder, the intelligent necklace establishes communication connection with the intelligent feeder by a Bluetooth module, and uploads moving data to the cloud data server by the network, moving amount is input to the cloud data server, the feeding amount of this meal is calculated by a complex algorithm according to variety, age, sex, body weight, standard feeding amount and standard calorie information of the pet, the cloud data server sends a command to the intelligent feeder which receives the feeding amount command, and the control unit controls a discharging motor to rotate by certain circles; the feeding amount is different according to different pet food varieties, and the data is obtained by experiment and matched with a relation between the pet food feeding amount and rotation of the motor; after discharging, the control unit controls the discharging motor to rotate, and pushes a food bowl filled with the pet food out of the intelligent feeder for the pet to enjoy; after set time, the control unit controls the discharging motor to recover the food bowl no matter the pets eats up or not, after recovery, the control unit controls the electronic scale to weigh residual pet food, an accurate value of this time feeding is obtained and is uploaded to the cloud data server, and once feeding is finished.

2. The pet health and life management system having a self-learning capability according to claim 1, wherein the system also comprises an intelligent dispenser, which is used for automatically detecting the balance of water, knowing everyday drinking amount of the pet and judging everyday water uptake of the pet.

3. A pet health and life management system having a self-learning capability, comprising: a cloud data server, an intelligent feeder and an intelligent portable device;
wherein the cloud data sever is connected with the intelligent feeder, and the intelligent feeder is connected with the intelligent portable device;
wherein the intelligent portable device is arranged on or in the pet for acquiring activity information of the pet, and sending the acquired information to the cloud data sever or/and the corresponding intelligent feeder;
wherein the cloud data server or/and the intelligent feeder is/are used for customizing a feeding scheme for the pet according to respective pieces of activity information of the pet, and the intelligent feeder acquires the feeding scheme; the intelligent feeder controls output feeding amount according to a corresponding feeding scheme.

4. The pet health and life management system having a self-learning capability according to claim 3, wherein the system also comprises at least one intelligent client, and the intelligent client is connected with the intelligent feeder and the intelligent portable device;
the cloud data server or/and the intelligent feeder/or/and the intelligent client is/are used for customizing a feeding scheme for the pet according to respective pieces of activity information of the pet, and the intelligent feeder acquires the feeding scheme.

5. The pet health and life management system having a self-learning capability according to claim 3, wherein an optimal feeding scheme reference table is stored in the cloud data server, and has corresponding pet food weights aiming at different varieties, different ages, different sexes, different pet food, different body weights, different activities and different seasons.

6. The pet health and life management system having a self-learning capability according to claim 5, wherein the cloud data server comprises a self-learning module, which is used for acquiring body weight and activity of the pets every set time interval; comparing a body weight curve of each pet with a set body weight curve, adding 1 to the comparative value of corresponding variety pet if the comparative value exceeds a set threshold value, and correcting the optimal feeding scheme reference table if the comparative value is up to the set value; reducing the corresponding feeding amount in the optimal feeding scheme reference table if the body weight is increased too fast, and increasing the corresponding feeding amount in the optimal feeding scheme reference table if the body weight is increased too slow; and then setting the comparative value of pet of such variety as 0.

7. The pet health and life management system having a self-learning capability according to claim 3, wherein the intelligent portable device is used for collecting everyday activity information of the pet, calculating corresponding calorie consumption, and establishing communication with the mobile intelligent client or the intelligent feeder to transmit data to the cloud data sever, the cloud data sever synthesizes various pieces of information, and obtains the food amount which is should be fed every day or every meal and issues a command to the intelligent feeder which feeds the pet;
as the moving amount of the pet is different every day, consumption of calories is different, the cloud data sever balances the different between the calorie consumption converted according to the moving amount of the pet and the standard calorie required amount to dynamically adjust feeding amount, so as to avoid too much or too little food eating of the pet and avoid excessive obesity or leanness;
the cloud data server performs horizontal comparison on myriads of pet dogs of the same variety, same sex and same age in the system and further adjusts the everyday feeding amount to enable the feeding amount of the pets to be more precise, scientific and reasonable.

8. The pet health and life management system having a self-learning capability according to claim 7, wherein the intelligent portable device is a pet intelligent necklace, which is wore on pet's neck.

9. The pet health and life management system having a self-learning capability according to claim 3, wherein the intelligent pet feeder mainly consists of a central processing unit, a communication unit, a food storage barrel, a discharging mechanism, an electronic scale, a telescopic feeding bowl, a camera, a first motor and a second motor; the central processing unit is respectively connected with the communication unit, the electronic scale, a transmission mechanism, the camera, the first motor and the second motor;
the pet food storage barrel is arranged at the upper half part of the intelligent feeder, and can store the pet food of more than 5 kg, the spiral discharging mechanism is arranged at the bottom of the storage barrel, and the telescopic feeding bowl is arranged at the lower half part of the food storage barrel; two motors are arranged in the intelligent feeder, the first motor is used for rotation of the discharging mechanism and the second motor is used for telescoping the feeding bowl; weighing sensors are arranged at the bottom of the whole intelligent feeder and are controlled by the central processing unit for precisely controlling weight of the consumed pet food;
the intelligent feeder is connected to the Internet by WiFi, establishes communication with the cloud data server, establishes communication with other intelligent equipment by Bluetooth, transmits data to the cloud data server, and receives a command of the cloud data server to operate.

10. The pet health and life management system having a self-learning capability according to claim 9, wherein a high definition camera and a microphone are arranged at the front surface of the intelligent feeder, a horn is arranged at the side surface and controlled by the central processing unit, the intelligent feeder can directly establish video communication with the mobile intelligent client.

11. The pet health and life management system having a self-learning capability according to claim 3, wherein the system also comprises intelligent camera devices, which is connected with the cloud data server, for acquiring audio and video information of the pet.

12. The pet health and life management system having a self-learning capability according to claim 3, wherein the system also comprises an intelligent water dispenser, which is connected with the intelligent feeder, the intelligent water dispenser is used for automatically detecting the balance of water, knowing everyday drinking amount of the pet anytime and judging everyday water uptake of the pet.

13. The pet health and life management system having a self-learning capability according to claim 3, wherein the system also comprises an intelligent electronic scale; which is connected with the intelligent client; the intelligent electronic scale is used for acquiring the body weight information of the pet; the intelligent electronic scale transmits the body weight data measured every day to the cloud data server by the mobile intelligent client or the intelligent feeder, if the condition that the pet is too much fat or thin is found, the cloud data server adjusts the everyday feeding amount at proper time, and through such a cyclic process, the system dynamically adjusts the feeding amount and keeps the pet healthy.

14. The pet health and life management system having a self-learning capability according to claim 3, wherein the cloud data server is the center of the whole system and raw data, comprising:
1) all pet dog varieties defined by AKC, average body weight of adult male and female pets, and pup average body weight defined by science research;
2) popular pet food brand and variety on the market and calorie contents of corresponding pet food;
3) everyday required calorie uptake relative to the variety, age and body weight of the pet dogs suggested by experts through science research;
4) everyday required water uptake relative to the variety, age and body weight of the pet dogs suggested by experts through science research.

15. A pet health and life management method of having a self-learning capability, wherein comprising following steps:
the intelligent portable device is arranged on or in the pet for acquiring activity information of the pet, and sending the acquired information to the corresponding intelligent client or/and cloud data sever or/and the corresponding intelligent feeder;
the cloud data server or/and the intelligent client or/and the intelligent feeder is/are used for customizing a feeding scheme for the pet according to respective pieces of activity information of the pet, and the intelligent feeder acquires the feeding scheme;
the intelligent feeder controls output feeding amount according to a corresponding feeding scheme.

16. The pet health and life management method of having a self-learning capability according to claim 15, wherein the method comprises the following steps:
moving data of the pet is collected by the intelligent portable device; then the intelligent feeder sends specific sound of feeding to call the pet to come over to eat when it's time to feed the pet;
when the pet approaches to the intelligent feeder, the intelligent portable device establishes communication connection with the intelligent feeder by Bluetooth, and uploads moving data to the cloud data server by the network;
moving amount is input to the cloud data server, the feeding amount of this meal is calculated by a complex algorithm according to variety, age, sex, body weight, standard feeding amount and standard calorie information of the pet;
the cloud data server sends a command to the intelligent feeder which receives the feeding amount command, and the control unit controls a discharging motor to rotate by certain circles; the feeding amount is different according to different pet food varieties, and the data is obtained from the optimal feeding scheme reference table arranged in the cloud data server and matched with a relation between the pet food feeding amount and rotation of the motor;
after discharging, the control unit controls the discharging motor to rotate, and pushes a food bowl filled with the pet food out of the intelligent feeder for the pet to enjoy;
after set time, the control unit controls the discharging motor to recover the food bowl no matter the pets eats up or not, after recovery, the control unit controls the electronic scale to weigh residual pet food, an accurate value about this time feeding is obtained and is uploaded to the data server, and once feeding is finished.

17. The pet health and life management method of having a self-learning capability according to claim 16, wherein the method comprises following step:
the mobile intelligent client starts a video communication function of the intelligent feeder by video button operation, and a pet owner can communicate with the pet remotely and see the condition of the pet.
